(19) United States
(12) Patent Application Publication
(10) Pub. No.: US 2008/0061008 A1
(43) Pub. Date: Mar. 13, 2008

(54) Systems and methods for treating metalworking fluids

(76) Inventors: Robert L. Kelsey, Fair Oaks Ranch, TX (US); Qiwei Wang, San Antonio, TX (US)

Correspondence Address: MEYERTONS, HOOD, KIVLIN, KOWERT & GOETZEL, P.C., P.O. BOX 398, AUSTIN, TX, 78767-0398, US

(21) Appl. No.: 11/519,986

(22) Filed: Sep. 12, 2006

(51) Int. Cl. C02F 1/68

(52) U.S. Cl. 210/764

(57) ABSTRACT

Metalworking fluid may include biological contaminants. In various embodiments, a metalworking fluid may be sent to a fluid treatment system to reduce the amount of biological contaminants in the metalworking fluid. In some embodiments, a fluid treatment system may include a first vortex nozzle unit positioned in an opposed relation to a second vortex nozzle unit. Contacting the metalworking fluid exiting the first vortex nozzle unit with the metalworking fluid exiting the second vortex nozzle unit may destroy at least a portion of the biological contaminants in the metalworking fluid.

### BACKGROUND OF THE INVENTION

1. Field of the Invention

The present invention relates to treating metalworking fluids. More particularly, the invention relates to reducing, eradicating, and/or controlling the concentration of biological contaminants in metalworking fluids.

2. Brief Description of the Related Art

On a daily basis over 1 million workers are potentially exposed to metalworking fluids (“MWFs”), often by breathing MWF vapors and MWF aerosol droplets (e.g., the mist and all contaminants in the mist) generated during grinding or machining of metal parts or through skin contact with the fluids when they handle parts, tools, or equipment at least partially coated with metalworking fluids. The National Institute for Occupational Safety and Health (NIOSH) has reported that exposure to MWFs may cause a variety of health problems including: respiratory conditions such as, hypersensitivity pneumonitis, chronic bronchitis, impaired lung function, and asthma; dermatological conditions such as, allergic and irritant dermatitis; and/or an increased risk of cancer. Exposure to MWFs may also cause tuberculoses. The chemicals contained in MWFs, notably biocides, substantially contribute to the health problems noted above. Exposure to bacteria and mycobacterium in MWFs also pose health and safety concerns. Studies have indicated that when MWF operators take sick time approximately one third of the sick time is attributed to conditions caused by their exposure to MWFs (e.g., lung irritations).

NIOSH recommends that exposures to MWF aerosols be limited to 0.4 milligrams per cubic meter of air (thoracic particulate mass), as a time-weighted average concentration up to 10 hours per day during a 40-hour workweek [http://www.cdc.gov/niosh/98-102.html]. The recommended exposure limit is intended to prevent or greatly reduce respiratory disorders associated with MWF exposure; however, some workers have developed work related asthma, hypersensitivity pnemonitis, or other adverse respiratory effects when exposed to MWFs at lower concentrations.

Currently, some preventive measures are available to reduce MWF exposures and their effects. Some formulations have been developed with safer, less irritating additives and MWF components. Machinery has been modified to limit the dispersal of MWF mists. In addition, the use of protective gloves, aprons, and clothing, the education of workers regarding the safe handling of MWFs, and the importance of workplace personal hygiene are all key to controlling the exposures to MWF. However, there still currently exists a need to eliminate or reduce the usage of irritant chemicals and biocides in MWFs. Any changes to formulations or treatments of MWFs, however, should still control the biological contaminant levels in MWFs to levels equal to or less than biological contaminants levels obtained by the current use of biocides and best available preventative measures while, at the same time, maintaining the desirable fluid characteristics of MWFs, increasing the useful life of MWFs, maintaining a more stable emulsion, and improving worker safety.

### SUMMARY OF THE INVENTION

In an embodiment, the amount of biological contaminants in a MWF's may be reduced and controlled to acceptable cfu/ml levels: without the use of biocides; using trace amounts of biocides; or using trace amounts of a combination of biocides and non-biocides in conjunction with a fluid treatment system. A fluid treatment system includes a first vortex nozzle unit and a second vortex nozzle unit positioned in opposed relation to the first vortex nozzle unit. A MWF is introduced into the fluid treatment system. A first portion of the MWF flows through the first vortex nozzle unit and a second portion of the MWF flows through the second vortex nozzle unit. The MWF exiting the first vortex nozzle unit is brought into contact with the second portion of the MWF exiting the second vortex nozzle unit. Contact of the first portion of the MWF with the second portion of the MWF destroys at least a portion of the biological contaminants in the MWF.

Depending on the use and characteristics of the MWF, a vortex nozzle based fluid treatment system may: a) reduce the need to use harmful and environmentally unfriendly biocides to control biological contaminants; b) reduce the use of specific biocides to control biological contaminants; c) use non-biological surfactants and emulsifies to control biological contaminants; or d) use specific combinations of trace amounts of biocide and non-biological products to control biological contaminants.

In an embodiment, the MWF is a water-based MWF. The MWF may be a soluble oil MWF, a semisynthetic MWF, or a synthetic MWF. In some embodiments, the MWF may include a vegetable oil. MWFs may be manufactured from concentrates. In use MWFs are prepared by mixing/diluting a MWF concentrate with water. Generally, the MWF concentrate to water percent volume ratios vary from 0.05 to 0.2.

Each vortex nozzle unit may include a single pair of vortex nozzles or multiple vortex nozzle units. In an embodiment, a pair of opposed vortex nozzles (a first vortex nozzle and a second vortex nozzle) are used in a fluid treatment system. In an embodiment of a fluid treatment system, at least one of the first vortex nozzle unit and the second vortex nozzle unit has a plurality of vortex nozzles. When a vortex nozzle unit includes a plurality of vortex nozzles, the vortex nozzles may be arranged in a cascade configuration. During treatment of a MWF the first portion of a MWF flows through the first vortex nozzle unit and the second portion of the MWF flows through a second vortex nozzle unit approximately concurrently.

In one embodiment, the amount of eradication, control or reduction of biological contaminants in a MWF's may be modified by introducing an additive to the fluid treatment system. In some embodiments, the additive includes a biocide. In alternate embodiments, the additive includes a surfactant or an emulsifier. In some embodiments, the amount of additives may range from about 0.5 ppm to about 8.0 ppm of biocides, non-biocides (surfactants or emulsifiers) or combinations thereof.

In some embodiments the fluid treatment system may be used as a homogenizer to make MWFs with less surfactants and/or emulsifiers. In some embodiments, the fluid treatment system may be used to mix/blend the MWF concentrate with water to yield a homogenous, emulsified and stable MWF.

In some embodiments, the fluid treatment system may be coupled to a reservoir that includes a MWF. The reservoir may be coupled to metalworking machinery. MWF may be supplied to the metalworking machinery from the reservoir. A conduit may couple the reservoir to an inlet of the fluid treatment system. An additional conduit may couple the fluid treatment system back to the reservoir. During use, at least a portion of the MWF exiting the fluid treatment system may be sent to the reservoir or distributed to metalworking machinery.

In an embodiment, the amount of biological contaminants in the MWF may be assessed prior to introducing the MWF into the fluid treatment system. The decision to send the MWF into the fluid treatment system may be based, at least in part, on the biological content of the MWF. For example, the MWF may be introduced into the fluid treatment system if the amount of biological contaminants exceeds a predetermined amount. Additionally, the MWF may be inhibited from entering the fluid treatment system if the amount of biological contaminants is less than a predetermined amount.

In another embodiment, a MWF system includes a reservoir that includes a MWF and a fluid treatment system. The fluid treatment system includes a first vortex nozzle unit and a second vortex nozzle unit positioned in opposed relation to the first vortex nozzle unit. A first conduit may couple the reservoir to an inlet of the fluid treatment system and a second conduit may couple an outlet of the fluid treatment system to the reservoir or to metalworking machinery.

In another embodiment, a fluid treatment system may be used to manufacture MWF concentrates with significantly reduced amounts of surfactants and emulsifiers. In an alternate embodiment, a fluid treatment system is used to mix/blend a MWF concentrate with water. A fluid treatment system for MWFs may be a continuous processing system, a batch processing system, or a semi-batch processing system, as required.

### BRIEF DESCRIPTION OF THE DRAWINGS

Features and advantages of the methods and apparatus of the present invention will be more fully appreciated by reference to the following detailed description of presently preferred but nonetheless illustrative embodiments in accordance with the present invention when taken in conjunction with the accompanying drawings in which:

FIG. 1 depicts an embodiment of a fluid treatment system;

FIG. 2 depicts a cross-sectional view of a fluid treatment system;

FIG. 3 is a perspective view of a fluid treatment system;

FIG. 4 is a cross-sectional view taken along lines 302, 302 of FIG. 1 illustrating a fluid treatment system;

FIG. 5 is a perspective view illustrating a vortex nozzle of the apparatus for treating fluids;

FIG. 6 is an alternate perspective view illustrating a vortex nozzle of the apparatus for treating fluids;

FIG. 7 is an elevation view illustrating an inlet side of a vortex nozzle body of the vortex nozzle;.

FIG. 8 is a cross-sectional view taken along lines 306, 306 of FIG. 5 illustrating the vortex nozzle body of the vortex nozzle;

FIG. 9 depicts a graph denoting the change in biological contaminants, E. Coli, during multiple passes through a fluid treatment system;

FIG. 10 depicts a graph denoting the change in biological contaminants, Heterophic Bacteria, during multiple passes through a fluid treatment system;

FIG. 11 depicts a graph denoting the change in biological contaminants contained in a MWF after 50 passes through a fluid treatment system at 94 psi, at 157 psi and with the use of 5 ppm of 1290; and

FIG. 12 depicts a schematic drawing of a MWF system.

While the invention is susceptible to various modifications and alternative forms, specific embodiments thereof are shown by way of example in the drawings and will herein be described in detail. The drawings may not be to scale. It should be understood that the drawings and detailed description thereto are not intended to limit the invention to the particular form disclosed, but to the contrary, the intention is to cover all modifications, equivalents and alternatives falling within the spirit and scope of the present invention as defined by the appended claims.

### DETAILED DESCRIPTION OF EMBODIMENTS

MWFs are used for their coolant, lubricant, and corrosion resistant properties during machining operations. Machine operations that involve metal removal processes (e.g., grinding, cutting, or boring of metal parts) generate heat during these processes. In order to meet productivity and quality requirements this heat is typically controlled by the use of MWFs. MWFs have two primary functions: to cool and to lubricate. Additionally, MWFs also provide corrosion protection for the newly machined part and machine tool.

There are two main types of MWFs, straight oil MWFs and water-based MWFs. Straight oil MWFs are made up primarily of mineral (petroleum) oils. Other oils of animal, marine or synthetic origin can also be used singly or in combination with straight oils to increase the wetting action and lubricity. Straight oils are not diluted with water before use.

Water-based MWFs can be subdivided into three different classes: soluble oil, semi-synthetic, and synthetic (also known as “full synthetic”). Soluble oil, semi-synthetic oil and synthetic oil MWF's are manufactured as concentrates and are designed to be diluted with water for the machining/grinding of metal parts. Soluble oil MWFs (also known as emulsifiable oil MWFs) are typically made up of from 30 to 85 percent oil in water. Soluble oil MWFs typically include 10 to 20 percent emulsifiers and/or surfactants to help disperse the oil in water. Soluble oil MWFs may also include 5 to 10 percent biocide and 10 to 20 percent corrosion inhibitors. Semi-synthetic MWF contains a lower amount of oil, for example, 5 to 50 percent oil in water. Semi-synthetic MWFs may also include 5 to 10 percent biocide, 10 to 20 percent lubricating additives, 5 to 10 percent corrosion inhibitors and 10 to 50 percent emulsifiers. Synthetic MWF formulations do not contain any petroleum oil, but may include biocides, corrosion inhibitors and lubricity additives. In some embodiments, lubricity additives may be polymeric. Synthetic MWF's include detergent-like components (water soluble polymers) to help “wet” the part and other additives to improve performance. Like the other classes of water-based MWFs, synthetics are designed to be diluted with water. Oils used in soluble oil MWFs, semisynthetic MWFs and synthetic MWFs include, but are not limited to: petroleum oils, mineral oils, animal oils, vegetable oils, and synthetic oils. Water-based MWFs may include additives such as emulsifiers, surfactants, biocides, extreme pressure agents, anti-oxidants, lubricating additives and corrosion inhibitors to improve performance and increase fluid life.

Water-based MWFs are prone to biological contamination. The term “biological contaminants” as used herein refers to bacteria, fungi, algae, cell components or their byproducts (e.g., endotoxins, exotoxins, and mycotoxins). Generally, biological contaminants are held in check by biocides present in MWFs. As the biocides are consumed or oxidized, the population of biological contaminants will experience rapid growth. The biological contaminants will begin to consume some of the oils in the MWFs, which may lead to the MWF becoming ‘rancid’ and less useful as a coolant and lubricator. To offset degradation of MWFs, some users may filter, remove tramp oils and add additives (e.g., biocides and pH adjusters) to the aging MWF to prolong the useful life of the MWF. Biological contaminates may be particularly prevalent in water-based MWFs that include vegetable oils.

In an embodiment, at least a portion of the biological contaminates in a MWF may be eradicated, reduced or controlled by treating the MWF in a fluid treatment system. In an embodiment, a fluid treatment system includes a first vortex nozzle unit positioned in opposed relationship to a second vortex nozzle unit, and a pressure-equalizing chamber that delivers a flow of MWF to each of the nozzle units. As used herein the term “vortex nozzle unit” refers to a single vortex nozzle or a plurality of vortex nozzles coupled together. The pressure-equalizing chamber receives a MWF from the pump and delivers the MWF into the first vortex nozzle unit and the second vortex nozzle unit. The first and second vortex nozzle units receive fluid therein and impart a rotation to the fluid, thereby creating a first rotating fluid stream and a second rotating fluid stream, respectively. The fluid treatment system further includes a collision chamber where impingement of the first rotating fluid flow with the second rotating fluid flow occurs.

In some embodiments, a fluid treatment system may include two sets of opposed cascaded vortex nozzles. For example, a vortex nozzle unit may include a cascaded vortex nozzle pair, which includes a first vortex nozzle having a second vortex nozzle, cascaded with it. The vortex nozzle unit further includes a second cascaded vortex nozzle pair, which includes a third vortex nozzle having a fourth vortex nozzle, cascaded with it. More particularly, the outlet from the second nozzle communicates with an inlet into the first nozzle and the outlet from the fourth nozzle communicates with an inlet into the second nozzle. Each of the four vortex nozzles receives a fluid through an inlet that communicates with a fluid source to impart a rotation to the fluid passing through them. The cascaded vortex nozzles are positioned in opposed relation and communicate with a chamber so that the fluid streams exiting the nozzles rotate in an opposite direction to collide at approximately the mid-point of the chamber. The two counter-rotating streams exiting the nozzles collide at a high velocity to create a compression wave throughout the fluid.

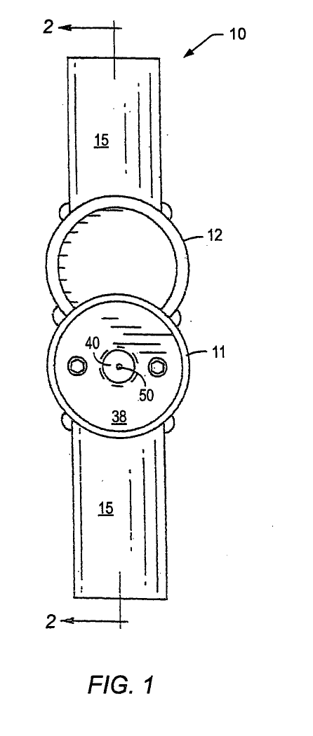

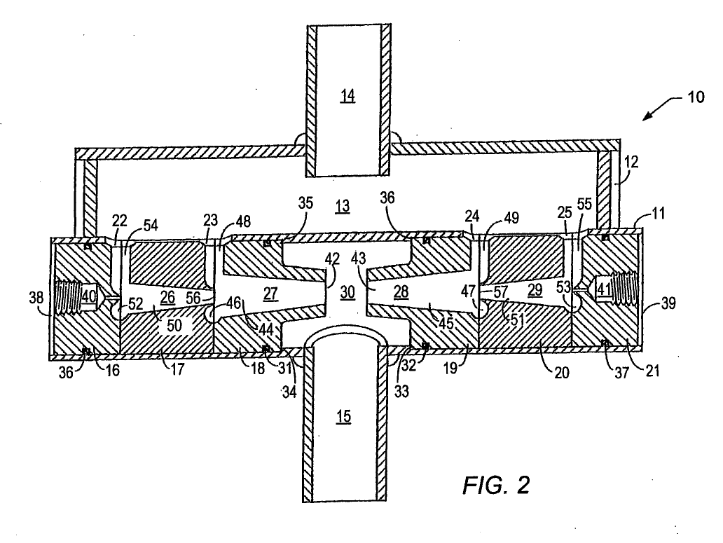

FIGS. 1 and 2 depict an embodiment of a fluid treatment system. Fluid treatment system 10 includes cylindrical body portions 11 and 12 formed integrally using any standard machining or molding process. Cylindrical body portion 12 defines chamber 13 and includes inlet 14 which may be attached to a MWF source. Cylindrical body 11 defines a chamber and includes outlet 15 that attaches to any suitable reservoir or any suitable fluid delivery means.

Cylindrical body portion 11 houses within its chamber vortex nozzle assembly blocks 16-21 (see FIG. 2). Additionally, cylindrical body 11 includes inlets 22-25 which communicate with chamber 13 of cylindrical body portion 12. The structure of vortex nozzle assembly blocks 16-21 are similar to those described in U.S. Pat. Nos. 4,261,521, 4,957,626, and 5,318,702, the disclosures of which are herein incorporated by reference. Each of vortex nozzle assembly blocks 16-21 are shaped to define a portion of vortex nozzles 26-29 using any standard machining or molding process. Vortex assembly blocks 16, 17, and 18 define the first vortex nozzle unit and vortex assembly blocks 19, 20, and 21 define the second vortex nozzle unit.

Vortex nozzle assembly blocks 18 and 19 are inserted within the chamber defined by cylindrical body portion 11 until their inner edges contact protrusions 33-35. (Note—should this say protrusims 33-36?) Protrusions 33-36 prevent vortex nozzle assembly blocks 18 and 19 from being inserted completely within the center of the chamber defined within cylindrical body portion 11. Vortex nozzle assembly blocks 18 and 19 reside 10 within the chamber defined within cylindrical body portion 11 such that they define chamber 30, which communicates with outlet 15. Vortex nozzle assembly blocks 18 and 19 include o-rings 31 and 32, respectively, which form a fluid seal between vortex nozzle assembly blocks 18 and 19 and the inner surface of cylindrical body portion 11.

After the insertion of vortex nozzle assembly blocks 18 and 19 to the position shown in FIG. 2, vortex nozzle assembly blocks 17 and 20 are inserted until they abut the rear portions of vortex nozzle assembly blocks 18 and 19, respectively. Finally, vortex nozzle assembly blocks 16 and 21 are inserted until they abut the rear portions of vortex nozzle assembly blocks 17 and 20, respectively. Vortex nozzle assembly blocks 16 and 21 include o-rings 36 and 37, respectively, which form a fluid seal between vortex nozzle assembly blocks 16 and 21 and the inner surface of cylindrical body portion 11.

Cylindrical body portion 11 includes plates 38 and 39 that fit within the entrances at either end of cylindrical body portion 11. Plates 38 and 39 mount over vortex nozzle assembly blocks 16 and 21, respectively, using any suitable means such as screws to secure vortex nozzle assembly blocks 16-21 with the chamber defined by cylindrical body portion 11.

With vortex nozzle assembly blocks 16-21 positioned and secured within the chamber defined by cylindrical body portion 11, vortex nozzle assembly blocks 16-21 define vortex nozzles 26-29 and conduits 40 and 41. Vortex nozzles 27 and 28 are positioned in opposed relation so that a stream of water exiting their outlets 42 and 43, respectively, will collide approximately at the mid-point of chamber 30. Vortex nozzle assembly blocks 18 and 19 define frustro-conical inner surfaces 44 and 45 of vortex nozzles 27 and 28, respectively. The abutment of vortex nozzle assembly block 17 with vortex nozzle block 18 defines circular portion 46 and channel 48, which communicates with inlet 23. Additionally, outlet 56 from vortex nozzle 26 communicates with circular portion 46 of vortex nozzle 27. Similarly, vortex nozzle blocks 19 and 20 define circular portion 47 and channel 49, which communicates with inlet 24, while outlet 57 from vortex nozzle 29 communicates with circular portion 47 of vortex nozzle 28.

Vortex nozzle assembly block 17 defines frustro-conical inner surface 50, while the abutment between vortex nozzle assembly blocks 16 and 17 defines circular portion 52 and channel 54, which communicates with inlet 22. Vortex nozzle assembly block 20 defines frustro-conical inner surface 51 and the abutment between vortex nozzle assembly blocks 20 and 21 defines circular portion 53 and channel 55, which communicates with inlet 25. Vortex nozzle assembly blocks 16 and 21 include conduits 40 and 41, respectively, which communicate to the exterior of cylindrical body portion 11 via opening 50 in plate 38 (see FIG. 1) and another opening in plate 39 (not shown). Conduits 40 and 41 permit additives to be introduced into vortex nozzles 26-29 during treatment of a fluid.

Thus, in operation, fluid is pumped into chamber 13 via inlet 14. The fluid flows from chamber 13 into each one of channels 54, 48, 49, and 55 via inlets 22-25, respectively, of cylindrical body portion 11. Channels 54, 48, 49, and 55 deliver the fluid to circular portions 52, 46, 47, and 53, respectively, of vortex nozzles 26-29. Circular portions 52, 46, 47, and 53 impart a circular rotation to the water and delivers the circularly rotating water streams into frustro-conical inner surfaces 50, 44, 45, and 51, respectively. Frustro-conical inner surfaces 50, 44, 45, and 51 maintain the circular rotation in their respective water stream and deliver the circularly rotating water streams to outlets 56, 42, 43, and 57, respectively, from vortex nozzles 26-29.

Due to the cascaded configuration of vortex nozzles 26 and 29, the water streams exiting their outlets 56 and 57 enter vortex nozzles 27 and 28, respectively. Those circularly rotating streams combine with the circularly rotating streams within vortex nozzles 27 and 28 to increase the velocity of the circularly rotating streams therein. Additionally, as the streams exiting vortex nozzles 26 and 29 contact the streams within vortex 27 and 28, they strike the circularly rotating streams within vortex nozzles 27 and 28 such that they create compression waves therein.

The combined streams from vortex nozzles 26 and 27 and the combined streams from vortex nozzles 29 and 28 exit vortex nozzles 27 and 28 at outlets 42 and 43, respectively, and collide at approximately the mid-point of chamber 30. The streams rotating within vortex nozzles 27 and 28 travel in the same direction, however, the streams are rotating oppositely as they exit vortex nozzles 27 and 28 because vortex nozzles 27 and 28 are positioned in an opposed relationship. As the exiting streams collide, additional compression waves are created which combine with the earlier compression waves to create compression waves having amplitudes greater than the original waves. The recombined water streams exit chamber 30 into outlet 15. The compression waves created by the collision of the exiting streams is sufficient to destroy at least a portion of biological contaminants that may be present in the MWF inputted into the system.

Although the above description depicts a pair of cascaded nozzles, such description has been for exemplary purposes only, and, as will be apparent to those of ordinary skill in the art, any number of vortex nozzles may be used.

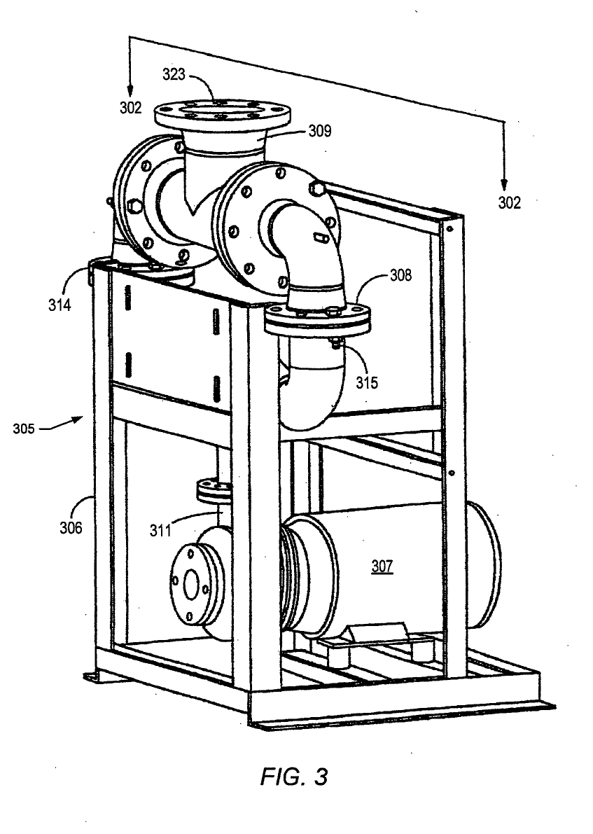

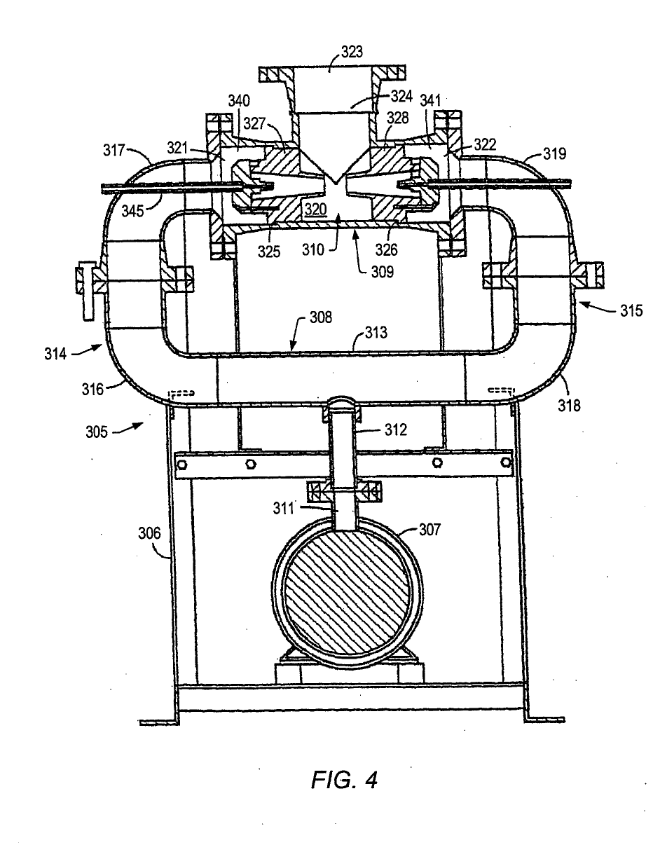

FIGS. 3 and 4 depict an apparatus 305 for treating MWFs that includes a frame 306 for supporting a pump 307 and a manifold 308 thereon, using any suitable attachment means, such as brackets. The apparatus 305 further includes a housing 309 secured to the manifold 308 and a vortex nozzle assembly 310 disposed in housing 309.

The pump 307 includes an outlet 311 and is any suitable pump capable of pumping fluid from a fluid source through the apparatus 305. Fluid, in this preferred embodiment, is any flowable liquid or gas or solid particulates deliverable under pressurized gas or liquid flow. Although this preferred embodiment discloses a pump 307 for delivering fluids, those of ordinary skill in the art will recognize many other suitable and equivalent means for delivering fluids, such as pressurized gas canisters.

Manifold 308 includes an inlet 312, a diverter 313, and elbows 314 and 315. Inlet 312 couples to outlet 311 of pump 307, using any suitable means, such as a flange and fasteners, to receive a fluid flow from the pump. Inlet 312 fits within an inlet of diverter 313 and is held therein by friction, welding, glue, or the like, to deliver fluid into the diverter. Diverter 313 receives the fluid flow therein and divides the fluid flow into a first fluid flow and a second fluid flow by changing the direction of fluid flow substantially perpendicular relative to the flow from inlet 312. Diverter 313 connects to elbows 314 and 315 by friction, welding, glue, or the like, to deliver the first fluid flow to elbow 314 and the second fluid flow to elbow 315. Each elbow 314 and 315 reverses its respective fluid flow received from the diverter 313 to deliver the fluid flow to housing 309. Elbow 314 includes elbow fittings 316 and 317, which connect together using any suitable means, such as a flange and fastener. Elbow fitting 317, in this preferred embodiment, includes a second flange to permit connection of elbow fitting 317 to housing 309. Similarly, elbow 315 includes elbow fittings 318 and 319, which connect together using any suitable means, such as a flange and fastener. Elbow fitting 319, in this preferred embodiment, includes a second flange to permit connection of the elbow fitting 317 to housing 309. Although this preferred embodiment discloses a manifold 308 for delivering fluid flow into housing 309, those of ordinary skill in the art will recognize many other suitable and equivalent means, such as two pumps and separate connections to housing 309 or a single pump delivering fluid into side portions of housing 309 instead of end portions.

Housing 309 includes inlets 321 and 322, an outlet 323, and detents 325 and 326. Housing 309 defines a bore 320 along its central axis and a bore 324 positioned approximately central to the midpoint of the housing 309 and communicating with bore 320. Housing 309 attaches between elbows 317 and 319, using any suitable means, such as flanges and fasteners, to receive the first fluid flow at inlet 321 and the second fluid flow at inlet 322. Outlet 323 is connectable to any suitable fluid storage or delivery system using well-known piping means.

Vortex nozzle assembly 310 resides within bore 320 and, in one embodiment, includes vortex nozzles 327 and 328, which are positioned within bore 320 of housing 309 in opposed relationship to impinge the first fluid flow with the second fluid flow, thereby treating the flowing fluid. With vortex nozzle 327 inserted into housing 309, vortex nozzle 327 and housing 309 define a cavity 340, which receives the first fluid flow from elbow 317 and delivers the first fluid flow to vortex nozzle 327. Similarly, with vortex nozzle 328 inserted into housing 309, vortex nozzle 328 and housing 309 define a cavity 341, which receives the second fluid flow from elbow 319 and delivers the second fluid flow to vortex nozzle 328.

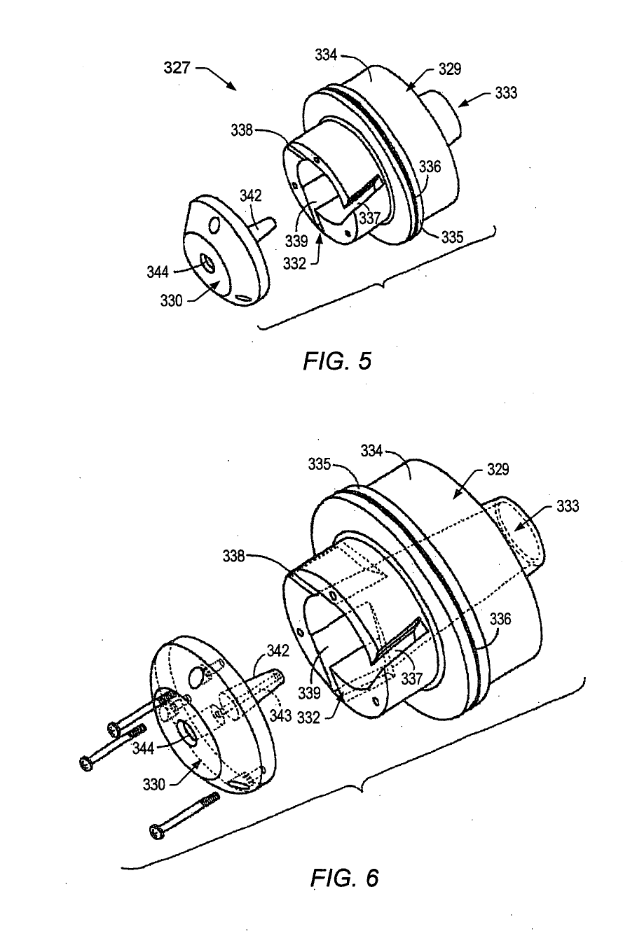

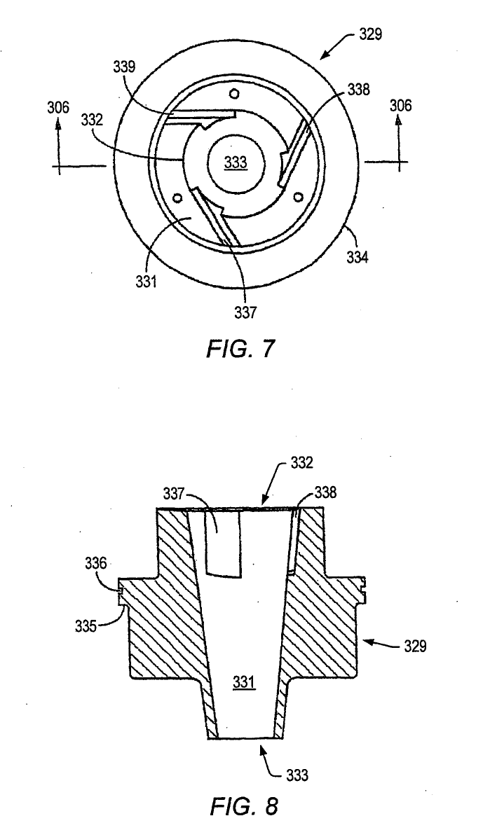

As illustrated in FIGS. 5-8, vortex nozzle 327 includes a nozzle body 329 and an end cap 330. For the purposes of disclosure, only vortex nozzle 327 will be described herein, however, it should be understood that vortex nozzle 328 may be identical in design, construction, and operation to vortex nozzle 327 and merely positioned within bore 320 of housing 309 in opposed relationship to vortex nozzle 327 to facilitate impingement of the second fluid flow with the first fluid flow.

Nozzle body 329, in this embodiment, is substantially cylindrical in shape and includes tapered passageway 331 located axially therethrough. The tapered passageway 331 includes an inlet side 332 and decreases in diameter until terminating at an outlet side 333. The taper of the tapered passageway 331 is greater than 0° and less than 90°. In some embodiments tapers are greater than 5° and less than 60°.

Nozzle body 329 includes a shoulder 334 having a raised portion 335 with a groove 336 therein. Shoulder 334 is sized to frictionally engage vortex nozzle 327 with an interior surface of housing 309, while raised portion 335 of the vortex nozzle abuts detent 325, thereby controlling the position of vortex nozzle 327 within the housing 309. Groove 336 receives a seal therein to fluidly seal nozzle body 329 with housing 309 and, thus, vortex nozzle 327 within housing 309.

Nozzle body 329 further includes ports 337-339 for introducing fluid into tapered passageway 331 of vortex nozzle 327. In this preferred embodiment, ports 337-339 are substantially trapezoidal in shape and are equally spaced radially about the nozzle body 329 beginning at inlet side 332. Although this embodiment discloses three substantially trapezoidally-shaped ports 337-339, those of ordinary skill in the art will recognize that any number of ports may be utilized. Furthermore, ports 337-339 may be any shape suitable to deliver fluid into the tapered passageway 331, such as elliptical, triangular, D-shaped, and the like.

In this embodiment, ports 337-339 are tangential to the inner surface of tapered passageway 331 and enter tapered passageway 331 at the same angle as the taper of the tapered passageway, which enhances the delivery of the fluid into tapered passageway 331 and, ultimately, the distribution of the fluid around the tapered passageway. Although this embodiment discloses tangential ports 337-339 angled with the taper of the tapered passageway 331, those of ordinary skill in the art will recognize that the ports 337-339 can enter tapered passageway 331 at any angle relative to the taper of the tapered passageway 331. Additionally, the end of nozzle body 329 defining inlet side 332 includes a taper the same angle as the taper of the tapered passageway 331 to ensure that ports 337-339 each define a substantially trapezoidal shape.

End cap 330 abuts the end of nozzle body 329 defining inlet side 332 to seal inlet side 332, thereby permitting fluid to enter into the tapered passageway 331 through ports 337-339 only. Accordingly, an inner face of end cap 330, that abuts the end of nozzle body 329 that defines inlet side 332, includes a taper the same angle as the taper of the tapered passageway 331. End cap 330 attaches to the end of nozzle body 329 defining inlet side 332 using any suitable means, such as fastening screws, glue, or the like. It should be understood, however, that end cap 330 may be formed integrally with nozzle body 329. Although this embodiment discloses an inner face of end cap 330 and end of nozzle body 329 defining inlet side 332 as including a taper the same angle as the taper of tapered passageway 331 to ensure ports 337-339 each define a substantially trapezoidal shape, those of ordinary skill in the art will recognize that inner face of end cap 330 and the end of nozzle body 329 defining the inlet side 332 may reside at any angle.

End cap 330 includes a boss 342 formed integrally therewith or attached thereto at approximately the center of the inner face of the end cap. In this embodiment, the boss 342 is conical in shape and extends into the tapered passageway 331 to adjust the force vector components of the fluid entering the tapered passageway 331. A passageway 343 through boss 342 communicates with a cavity 344 at approximately the center of the outer face of the end cap 330. A conduit 345 (see FIG. 4) fits within cavity 344 to permit measurement of a vacuum within tapered passageway 331.

A flow of fluid delivered to vortex nozzle 327 enters tapered passageway 331 via the ports 337-339. Tapered passageway 331 receives fluid therein and imparts a rotation to the fluid, thereby creating a rotating fluid flow that travels down the tapered passageway and exits its outlet side 333. Each port 337-339 delivers a portion of the fluid flow both tangentially and normally to tapered passageway 331. This tangential and normal entry of the fluid in multiple bands distributes the fluid uniformly in a thin rotating film about tapered passageway 331, which minimizes fluid losses due to internal turbulent motion. Accordingly, vortex nozzle 327 provides for a more intense and stable impact of rotating fluid flow exiting outlet side 333 of tapered passageway 331.

Additionally, in this embodiment, the cross-sectional area of ports 337-339 is less than the cross-sectional area of inlet side 332 of tapered passageway 331, which creates a vacuum within the rotating fluid flow. Nevertheless, those of ordinary skill in the art will recognize that the size of ports 337-339 may be varied based upon particular application requirements. The amount of vacuum created by ports 337-339 may be adjusted utilizing boss 342 to alter the force vectors of the rotating fluid flow. Illustratively, increasing the size of boss 342 (e.g., either diameter or length) decreases the volume within the tapered passageway 331 fillable with fluid, thereby increasing the vacuum and, thus, providing the rotating fluid flow with more downward and outward force vector components.

In operation, manifold 308 is assembled as previously described and connected to pump 307. Each of vortex nozzles 327 and 328 are inserted in opposed relationship into housing 309 as previously described, and housing 309 is connected to manifold 308. Pump 307 pumps fluid from a fluid source and delivers the fluid into manifold 308, which divides the fluid into a first fluid flow and a second fluid flow. Manifold 308 delivers the first fluid flow into cavity 340 of housing 309 and the second fluid flow into cavity 341 of housing 309. The first fluid flow enters vortex nozzle 327 from cavity 340 via the ports of the vortex nozzle 327. Vortex nozzle 327 receives the fluid therein and imparts a rotation to the fluid, thereby creating a first rotating fluid flow that travels down vortex nozzle 327 and exits its outlet side. Similarly, the second fluid flow enters vortex nozzle 328 from the cavity 341 via the ports of vortex nozzle 328. Vortex nozzle 328 receives the fluid therein and imparts a rotation to the fluid, thereby creating a second rotating fluid flow that travels down the vortex nozzle 328 and exits its outlet side. Due to the opposed relationship of the vortex nozzles 327 and 328, the first rotating fluid flow impinges the second rotating fluid flow, resulting in the treatment of the fluid through the breaking of molecular bonding in the fluid or the reduction in size of solid particulates within the fluid. The treated fluid then exits the outlet 323 of housing 309 and travels to a suitable fluid storage or delivery system.

Additional embodiments of fluid treatment systems that include vortex nozzles, and details regarding the above-described embodiments, can be found in the following U.S. Patents, all of which are incorporated herein by reference: U.S. Pat. No. 4,261,521, entitled “Method and Apparatus for Reducing Molecular Agglomerate Sizes in Fluids” to Ashbrook; U.S. Pat. No. 4,645,606, entitled “Magnetic Molecular Agglomerate Reducer and Method” to Ashbrook et al.; U.S. Pat. No. 4,764,283, entitled “Method and Apparatus for Treating Cooling Tower Water” to Ashbrook et al.; U.S. Pat. No. 4,957,626, entitled “Method and Apparatus for Treating Water in Beverage and Ice Machines” to Ashbrook; U.S. Pat. No. 5,318,702, entitled “Fluid Treating Apparatus” to Ashbrook; U.S. Patent No. 5,435,913, entitled “Fluid Treating Apparatus” to Ashbrook; U.S. Pat. No. 6,045,068, entitled “Method for Treating Cement Slurries” to Ashbrook; U.S. Pat. No. 6,649,059, entitled “Apparatus for Treating Fluid” to Romanyszyn et al; U.S. Pat. No. 6,712,968 entitled “Apparatus for Treating Fluid” to Romanyszyn; U.S. Pat. No. 6,797,170 entitled “Method and Apparatus for Treating Fluid” to Romanyszyn; U.S. Pat. No. 6,811,698 entitled “Method and Apparatus for Treating Fluid” to Romanyszyn; U.S. Pat. No. 6,811,712 entitled “Method and Apparatus for Treating Fluid” to Romanyszyn; U.S. Provisional Patent Application No. 60/752,170; U.S. Provisional Patent Application No. 60/752,171; and U.S. Provisional Patent Application No. 60/752,168.

Processing MWFs with any of the above-described fluid treatment devices will eradicate at least a portion of the biological contaminants in the MWF. In some embodiments an additive may be added to one or more of the sets of nozzles to increase the amount of biological contaminants eradicated or reduced. In an embodiment, at least a portion of the contacted MWF may be recycled to a MWF reservoir via one or more return lines or sent directly to metalworking machinery.

In some embodiments, a fluid treatment system may include an inlet. The inlet may be coupled to a MWF line and/or MWF reservoir. The MWF reservoir may be coupled to the metalworking machinery to supply MWF to the machinery during use. MWF may be drawn from the reservoir as needed by the metalworking machinery. After the MWF is used by the metalworking machinery, the MWF may be returned to the reservoir. The concentration of biological contaminants in the reservoir and/or in lines coupling the reservoir to the metalworking machinery may be monitored. When the concentration of biological contaminants (e.g., bacteria) is not within a predetermined range, the MWF may be transferred from the MWF reservoir to a fluid treatment system. In an embodiment, MWF may be continuously processed by the fluid treatment system. That is the MWF may be continuously drawn from a MWF reservoir, into the fluid treatment system and returned to the MWF reservoir, to control the concentration of biological contaminants. Additionally, the concentration of biological contaminants in the fluid exiting the fluid treatment system may be monitored. If the fluid exiting the fluid treatment system is not within a predetermined acceptable range, the fluid may be recycled back into the system, an additive may be introduced into the system, and/or the amount of additive introduced to the system may be modified.

Pressure equalizing manifolds and/or stabilization chambers may be coupled to inlet the fluid inlet of a fluid treatment system. In some embodiments, a pump may be coupled to inlet to increase the velocity and/or pressure at which a MWF enters a vortex nozzle unit. In other embodiments, a pump is not coupled to the system. The inlet may be coupled to each vortex nozzle unit. If a vortex nozzle unit includes two or more vortex nozzles, the inlet may be coupled to each of the individual vortex nozzles. In such a situation, the MWF may approximately concurrently flow into each vortex nozzle.

In some embodiments, a flow divider may be coupled to the inlet. The flow divider may direct the flow of fluid into more than one vortex nozzle unit. The flow divider may change the direction of fluid flowing. In an embodiment, the flow divider may have a shape similar to a “Y”. A “Y” shaped flow divider may be advantageous, since the shape may allow a smoother transition of fluid flow than if a flow divider abruptly stopped and redirected fluid flow, such as with a “T” shaped flow divider. A “Y” shaped flow divider may also reduce the discharge head pressure caused by redirection, and thus increase the velocity of the resulting divided fluid streams, when compared with abruptly stopping and redirecting fluid flow.

In an embodiment, a MWF concentrate may be diluted (e.g., mixed with water) to produce a MWF that is ready for use. In some embodiments, a MWF concentrate may be blended with water in a fluid treatment system to form a more homogenously mixed composition or blend. For example, the MWF concentrate may be sent through an inlet to the vortex nozzle units to allow mixing of the MWF concentrate with water sent through an additional inlet of the vortex nozzle units. A MWF concentrate may be mixed with water to dilute the MWF concentrate in a ratio of MWF concentrate to water of approximately 5:95 to approximately 15:85. By adding water to the MWF concentrate or to MWFs being treated in a fluid treatment system, the concentration of the MWF may also be adjusted at the same time that the concentration of biological contaminants is reduced.

In some embodiments, a vortex nozzle unit may include more than one inlet that allows fluid to enter the vortex nozzle unit. An inlet may be a variety of shapes, including having a substantially trapezoidal, a substantially elliptical, a substantially triangular, or a substantially D-shaped cross sectional area. Inlets into the vortex nozzle unit may be approximately equally spaced radially about a nozzle. In certain embodiments, inlets into the vortex nozzle unit may be positioned such that fluid enters the vortex nozzle unit at a variety of points across the vortex nozzle unit.

When a vortex nozzle unit includes a plurality of vortex nozzles such nozzles may be similar or different in size and/or shape. A vortex nozzle may compress fluid flowing through the nozzle and/or increase the velocity of a fluid flowing through the nozzle. A vortex nozzle may have a shape that directs streams of MWF exiting the vortex nozzle to flow clockwise or counterclockwise. In an embodiment, the MWF flowing from a first vortex nozzle unit is rotating in a clockwise direction while fluid flowing from an opposed second vortex nozzle unit is rotating in a counterclockwise direction.

In some embodiments, the pressure of the MWF in a vortex nozzle unit may be in the range of approximately 50 psi to approximately 200 psi, approximately 80 psi to approximately 140 psi, or approximately 85 psi to approximately 120 psi. MWF may flow into a fluid treatment system at a flow rate of 1500 gallons per minute or less. In an embodiment, MWF may flow into a fluid treatment unit at a flow rate of approximately 70 to approximately 20 gallons per minute.

In some embodiments, hydrodynamic cavitation may occur as the MWF passes through a vortex nozzle unit and/or when exit streams from the vortex nozzle units contact each other. Hydrodynamic cavitation, in the context of this application, refers to a process where cavities and cavitation bubbles filled with a vapor and/or a gas mixture are formed inside fluid flow. In some embodiments, a plurality of vapor filled cavities and bubbles form if the pressure decreases to a level where the fluid boils.

Fluid and cavitation bubbles may initially encounter a region of higher pressure when entering one or more of the vortex nozzle units in the system and encounter a vacuum area, at which point vapor condensation occurs within the bubbles and the bubbles collapse. The collapse of cavitation bubbles may cause hydrodynamic cavitations and pressure impulses. In an embodiment, the pressure impulses within the collapsing cavities and bubbles may be on the order of up to 1000 lbs/in₂. Hydrodynamic cavitation and/or other forces exerted on the fluid (e.g., pressure impulse, side walls of the nozzles) may cause changes in solubility of dissolved gasses, pH changes, formation of free radicals, and/or precipitation of dissolved ions such as calcium, iron, and carbonate. In addition, shear forces created during hydrodynamic cavitation may cause destruction of at least a portion of the biological contaminants in the MWF.

In some embodiments, hydrodynamic cavitation and/or the physical and mechanical forces created as the MWF flows through the vortex nozzle units (e.g., shear collision and pressure/vacuum forces) may kill or at least partially injure biological contaminants. For example, when an organism is at least partially injured, the organism may be unable to maintain viability, growth, reproduction, metabolic activities, and/or adversely affect its environment. Biological contaminants in a MWF may be killed and/or partially injured by high shear, collision, rapid pressure/vacuum changes, hydrodynamic cavitation forces, and/or other hydrodynamic changes in the fluid as it passes through a fluid treatment system. In an embodiment, biological contaminants may not be able to survive in the hydrodynamic cavitation region formed in a vortex nozzle unit and/or proximate an outlet of a vortex nozzle unit. Hydrodynamic and/or shear forces may lyse cells such as bacteria and fungi.

Additionally, when streams of fluids containing water with a speed of at least 450 mph collide (e.g., between 450 mph to 600 mph), at least some of the oxygen-hydrogen bonds in the water may be ruptured. The fragments from the collision may reform to produce hydrogen peroxide and other highly reactive intermediates. Hydrogen peroxide and/or the other highly reactive intermediates formed by hydrodynamic cavitation and the high-speed collision of water may destroy at least a portion of the biological contaminants in the fluid.

In some embodiments, one or more additives may be introduced into one or more of the vortex nozzle units via one or more additive inlets. Additives may include biocides and nonbiocides. Trace amounts of biocides may be used to decrease the concentration of microbiological organisms in the MWF when used in combination with a fluid treatment system. Biocides may include aldehydes, formaledehyde releasing compounds, halogenated hydrocarbons, phenolics, amides, halogenated amines and amides, carbamates, heterocyclic compounds including nitrogen and sulfur atoms at least in the ring portion of the structure, electrophilic active substances having a halogen group in the α position and/or in the vinyl position to an electronegative group, nucleophilic active substances having an alkyl group and at least one leaving group, surface active agents, and/or combinations thereof. For example, biocides may include linear, branched, or aromatic aldehydes such as glutaraldehyde; halogenated, methylated nitro-hydrocarbons such as 2-bromo-2-nitro-propane-1,3,-diol (Bronopol); halogenated amides such as 2,2-dibromo-3-nitrilopropionamide (DBNPA); thiazole; isothiazolinone derivatives such as 5-chloro-2-methyl-4 isothiazolin-3-one and 2-methyl-4-isothiazonlin-3-one; 1,2-dibromo-2,4-dicyanobutane, bis(trichloromethyl)sulfone, 4,5-dichloro-1,2-dithiol-3-one, 2-bromo-2-nitrostyrene; 2-n-octyl-4-isothiazolin-3-one; 4,5-dichloro-2-(n-octyl)-4-isothiazolin-3-one; 1,2-benzisothiazolin; o-phthalaldehyde; 2-bromo-4′-hydroxyacetophenone; methylene bisthiocyanate (MBTC); 2-(thiocyanomethylthio)benzothiazole; 3-iodopropynyl-N-butylcarbamate; n-alkyl dimethyl benzyl ammonium chloride; didecyl dimethyl ammonium chloride; alkenyl dimethylethyl ammonium chloride; 4,5-dichloro-1,2-dithiol-3-one; decylthioethylamine; n-dodecylguanidine hydrochloride; n-dodecylguanidine acetate; 1-(3-chloroallyl)-3,5,7-triaza-1-azoniaadamantane chloride; bis(1,4-bromoacetoxy)-2-butene; bis(1,2-bromoacetoxy)ethane; diiodomethyl-p-tolylsulfone; sodium o-phenylphenate; tetrahydro-3,5-dimethyl-2H-1,3,5-hydrazine-2-thione; cationic salts of dithiocarbamate derivatives; 4-chloro-3-mthyl phenol; 2,4,4′-trichloro-2′-hydroxy-diphenylether; poly(iminoimidocarbonyl-iminioimidocarbonyl-iminohexamethylene) hydrochloride; poly(osyethylene(dimethyliminio)ethylene-(dimethyliminio)ethylene dichloride; 4-chloro-2-(t-butylamino)-6-(ethylamino)-s-triazine; and/or combinations thereof.

However, it may not be desirable to use biocides in MWFs due to the health problems exposure to the biocides may cause. Currently, some companies have mandates to eliminate biocides in their operations and in MWFs. In some embodiments, nonbiocides may be introduced into one or more of the sets of nozzles. Nonbiocides may include surfactants and emulsifiers. Surfactants/emulsifiers may increase the speed and/or quantity of bacteria killed in the system. Although surfactants/emulsifiers may not kill bacteria alone, the use of surfactant/emulsifiers in a fluid treatment system may increase the quantity of bacteria killed when compared to using the fluid treatment system in the absence of a surfactant/emulsifier. In certain embodiments, an additive may include a surfactant known as PERFORM® 1290. Hydrophobic surfactants/emulsifiers allow fluids to more readily enter the cell walls and, when the cells are exposed to the forces of hydrodynamic cavitation, increases the kill rates. (See Table 1)

TABLE 1

| | Concentration of | Treatment | Percent Change in |
|---|---|---|---|
| Treatment | Additive | Time | Bacteria Population |
| Perform ® 1290 | 0.5 ppm for 10 min; | 30 min | +5.00 |
| (1.5 ppm) | 0.5 ppm for 10 min; | | |
| | 0.5 ppm for 10 min. | | |
| Perform ® 1290 | 0.5 ppm for 10 min; | 30 min | −99.47 |
| (1.5 ppm) + fluid | 0.5 ppm for 10 min; | | |
| treatment system | 0.5 ppm for 10 min. | | |

In an embodiment, DTEA (2-decylthioethylamine), and/or DTEA II (1-(decylthio)ethylamine), may be used as an additive. DTEA and/or DTEA II may disrupt coenzyme materials in cells necessary for photosynthesis and thus injure cells. The concentration and/or formulation of DTEA and/or DTEA II used in trace amounts without a fluid treatment system may not be sufficient to act as an effective biocide. DTEA and/or DTEA II, however, may increase the bacteria killing effectiveness of the system when used with a fluid treatment system (See Table 2).

TABLE 2

| | | | Percent Change in |
|---|---|---|---|
| | Concentration of | Treatment | Bacteria |
| Treatment | Additive | Time | Population |
| DTEA II | 1.0 ppm for 10 min. | 30 min. | +6.77 |
| (3.00 ppm) | 1.0 ppm for 10 min. | | |
| | 1.0 ppm for 10 min. | | |
| DTEA II | 1.0 ppm for 10 min. | 30 min. | −98.62 |
| (3.0 ppm) + fluid | 1.0 ppm for 10 min. | | |
| treatment | 1.0 ppm for 10 min. | | |
| system | | | |

In an embodiment, VANTOCIL 1 B (poly iminoimidocarbonyl—iminoimidocarbonyl—iminohexamethylene hydrochloride) may be used with the fluid treatment system as an additive in trace amounts. (See Table 3)

TABLE 3

| | | | Percent Change in |
|---|---|---|---|
| | Concentration of | Treatment | Bacteria |
| Treatment | Additive | Time | Population |
| Vantocil 1B | 0.1 ppm for 10 min; | 20 min | −66.28 |
| | 0.2 ppm for 10 min | | |
| Vantocil 1B + the | 0.1 ppm for 10 min; | 20 min | −97.57 |
| system | 0.2 ppm for 10 min | | |

An amount of additive may be introduced into the fluid treatment system to reduce a microbiological content of the MWF to a desired level or range. In some embodiments, approximately 0.1 to 6 ppm of additive of fluid may be introduced into the MWF reservoir and or system. The use of an additive may increase the system's effectiveness in eradicating biological contaminants. An additive may be able to increase a fluid treatment system's effectiveness in eradicating, reducing or controlling biological contaminants by a greater amount than the effectiveness of the additive alone, the fluid system alone or a combination of the additive alone and the fluid system alone.

In a fluid treatment system as described herein, a “pass” through the fluid treatment system is defined as passing a fluid through the system for a time sufficient to pass the entire volume of a reservoir through the system. For example, if a reservoir to be treated by the fluid treatment system is a 20-gallon reservoir, a “pass” is complete when 20 gallons of fluid from the reservoir has gone through the fluid treatment system.

In some embodiments, MWF flowing out of the fluid treatment system may be recycled through the fluid treatment system via one or more recycle lines. Recycling MWF through the fluid treatment system may further reduce the concentration of bacteria and other microorganisms in the MWF. In some embodiments, a portion of the MWF exiting the fluid treatment system may be mixed with a portion of the MWF entering the fluid treatment system through an inlet.

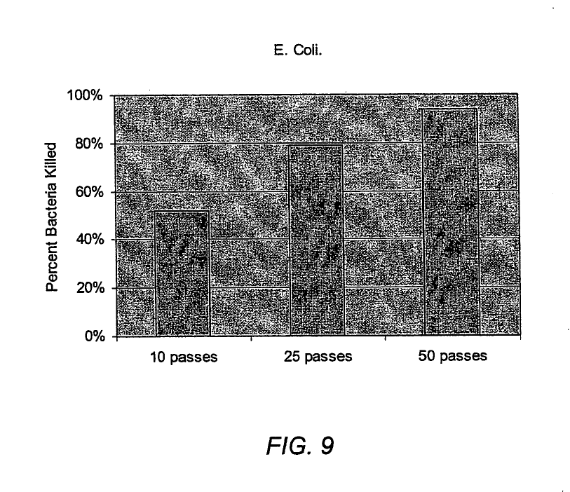

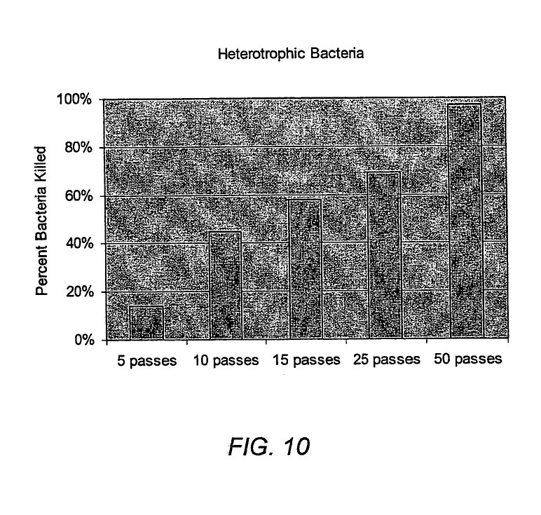

For example, FIG. 9 depicts examples of the percent of bacteria killed when E. coli is subjected to multiple passes through a fluid treatment system. In this experiment, a fluid that includes E. Coli bacteria was subjected to 10, 25, and 50 passes through a fluid treatment system commercially available from VRTX, San Antonio. The bacteria population was determined before and after the fluid was treated with the fluid treatment system using Method 9215B from the “Standard Methods for the Examination of Water and Wastewater.” As depicted in FIG. 9, the percentage of bacteria killed increases as the number of passes through the fluid treatment system increases. A similar test was run on a fluid that includes heterotrophic bacteria (See FIG. 10).

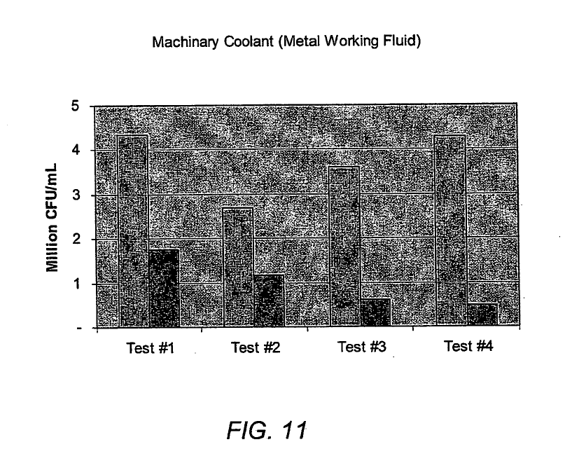

In another experiment, a MWF was treated in a fluid treatment system (VRTX, San Antonio). The results of these tests are presented in FIG. 11. In each experiment, the concentration of bacteria in the fluid before treatment is depicted by the left bar and the concentration of bacteria in the fluid after treatment is depicted in the right bar. In test 1, the MWF was subjected to 50 passes through the fluid treatment system at a pressure of 94 psi (low pressure). The amount of bacteria killed in test 1 was 59% of the initial population. In test 2, the MWF was subjected to 50 passes through the fluid treatment system at low pressure with the addition of 5 ppm Perform® 1290. The amount of bacteria killed in test 2 was 57% of the initial population. In test 3, the MWF was subjected to 50 passes through the fluid treatment system at a pressure of 157 psi (high pressure). The amount of bacteria killed in test 3 was 83% of the initial population. In test 4, the MWF was subjected to 50 passes through the fluid treatment system at high pressure. The amount of bacteria killed in test 4 was 89% of the initial population. The bacteria population for each test was determined before and after the fluid was treated with the fluid treatment system using Method 9215B from the “Standard Methods for the Examination of Water and Wastewater.”

In some embodiments, the system may monitor and/or control the concentration of biological contaminants in the MWFs. For example, bacteria concentration may be monitored continuously or periodically (e.g., using a dipstick). Monitoring the concentration of biological contaminants continuously or periodically may allow the fluid treatment system to adjust flow rates, the number of recycles through the system, and/or the amount and/or type of additive introduced into the system so that the concentration of biological contaminants may be maintained within a desired range in MWFs.

For example, it may be desirable to maintain the level of bacterial content to be from approximately 500,000 cfu's/ml up to 4,000,000 cfu's/ml. Bacterial counts, at a minimum, are to be equal to or less than an average cfu's/ml value obtained with the use of traditional amounts of biocides.

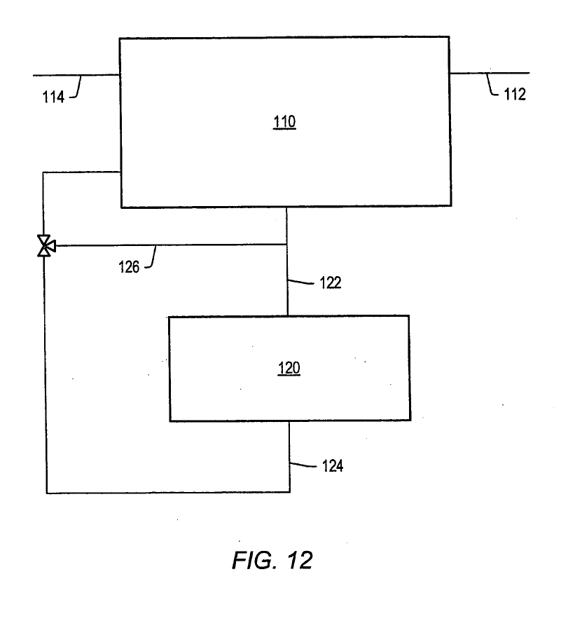

In an embodiment, a MWF system includes a reservoir 110 and a fluid treatment system 120 coupled to the reservoir, as depicted in FIG. 12. The reservoir holds MWF and supplies the MWF to metalworking machinery. Conduits 112 and 114 may be used to conduct MWF to metalworking machinery or from the metalworking machinery back to reservoir 110. A conduit 122 may couple the reservoir to an inlet of fluid treatment system 120. An additional conduit 124 may couple the fluid treatment system back to the reservoir. During use, at least a portion of the MWF exiting the fluid treatment system may be recycled back into the fluid treatment system, rather than being sent to the reservoir or distributed to metalworking machinery. A recycle conduit 126 may be coupled to exit conduit 124 to allow the MWF to be recycled. A three-way valve may be positioned at the intersection of conduits 124 and 126 to control the flow of the MWF.

In an embodiment, the amount of biological contaminants in the MWF may be assessed prior to introducing the MWF into the fluid treatment system. For example, a sample from the reservoir may be removed and tested for biological contaminants. Alternatively, in-line monitoring equipment -may be coupled to conduits 112 and 114 to allow continuous monitoring of the biological contaminants in the reservoir. The MWF may be introduced into the fluid treatment system if the amount of biological contaminants exceeds a predetermined amount. In one embodiment, the concentration of bacteria in the MWF is assessed prior to introducing the MWF into the fluid treatment system. The MWF is introduced into the fluid treatment system if the concentration of bacteria exceeds a predetermined amount. In an embodiment, the amount of biological contaminants in the MWF may be assessed prior to introducing the MWF into the fluid treatment system. The MWF may be inhibited from entering the fluid treatment system if the amount of biological contaminants is less than a predetermined amount.

In an embodiment, the fluid treatment system is used in the manufacture of MWF concentrate to reduce the amount of surfactants and emulsifiers needed to make such concentrates. In another embodiment, the fluid treatment system is used to mix/blend the MWF concentrate with water to yield a homogenous MWF.

It is to be understood that the terminology used herein is for the purpose of describing particular embodiments only, and is not intended to be limiting. As used in this specification, the singular forms “a”, “an” and “the” include plural referents unless the content clearly indicates otherwise. Thus, for example, reference to “a nozzle” includes a combination of two or more nozzles and reference to “bacteria” includes mixtures of different types of bacteria.

In this patent, certain U.S. patents and other materials (e.g., articles) have been incorporated by reference. The text of such U.S. patents, and other materials is, however, only incorporated by reference to the extent that no conflict exists between such text and the other statements and drawings set forth herein. In the event of such conflict, then any such conflicting text in such incorporated by reference U.S. patents and other materials is specifically not incorporated by reference in this patent.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as the presently preferred embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

1. A method of treating metalworking fluids comprising biological contaminants, the method comprising:
introducing a metalworking fluid into a fluid treatment system, the fluid treatment system comprising a first vortex nozzle unit and a second vortex nozzle unit positioned in substantially opposed relation to the first vortex nozzle unit;
allowing a first portion of the metalworking fluid to flow through the first vortex nozzle unit;
allowing a second portion of the metalworking fluid to flow through the second vortex nozzle unit;
allowing the first portion of the metalworking fluid exiting the first vortex nozzle unit to contact the second portion of the metalworking fluid exiting the second vortex nozzle unit;
wherein contacting the first portion of the metalworking fluid with the second portion of the metalworking fluid kills or injures at least a portion of the biological contaminants in the metalworking fluid.

2. The method of claim 1, wherein the metalworking fluid is a water-based metalworking fluid.

3. The method of claim 1, wherein the metalworking fluid is a soluble oil metalworking fluid.

4. The method of claim 1, wherein the metalworking fluid is a semisynthetic metalworking fluid.

5. The method of claim 1, wherein the metalworking fluid is a synthetic metalworking fluid.

6. The method of claim 1, wherein the metalworking fluid comprises a vegetable oil.

7. The method of claim 1, wherein at least one of the first vortex nozzle unit and the second vortex nozzle unit has a single vortex nozzle.

8. The method of claim 1, wherein at least one of the first vortex nozzle unit and the second vortex nozzle unit has a plurality of vortex nozzles.

9. The method of claim 8, wherein the plurality vortex nozzles are in a cascade configuration.

10. The method of claim 1, further comprising introducing an additive to at least one of the first vortex nozzle unit and the second vortex nozzle unit.

11. The method of claim 10, wherein the additive comprises a biocide.

12. The method of claim 10, wherein the additive comprises a surfactant.

13. The method of claim 10, wherein the additive comprises DTEA II.

14. The method of claim 10, wherein the additive comprises PERFORM® 1290.

15. The method of claim 10, wherein the additive comprises Vantocil.

16. The method of claim 10, wherein the additive may be a combination of a biocide and a non-biocide.

17. The method of claim 1, further comprising coupling the fluid treatment system to a reservoir comprising metalworking fluid, wherein the reservoir is coupled to metalworking machinery.

18. The method of claim 1, further comprising recycling at least a portion of the contacted metalworking fluid back into the fluid treatment system.

19. The method of claim 1, wherein the first portion of a metalworking fluid flows through the first vortex nozzle unit and the second portion of the metalworking fluid flows through a second vortex nozzle unit approximately concurrently.

20. The method of claim 1, further comprising assessing the amount of biological contaminants in the metalworking fluid prior to introducing the metalworking fluid into the fluid treatment system, wherein the metalworking fluid is introduced into the fluid treatment system if the amount of biological contaminants exceeds a predetermined amount.

21. The method of claim 1, further comprising assessing the concentration of bacteria in the metalworking fluid prior to introducing the metalworking fluid into the fluid treatment system, wherein the metalworking fluid is introduced into the fluid treatment system if the concentration of bacteria exceeds a predetermined amount.

22. The method of claim 1, further comprising assessing the amount of biological contaminants in the metalworking fluid prior to introducing the metalworking fluid into the fluid treatment system, wherein the metalworking fluid is inhibited from entering the fluid treatment system if the amount of biological contaminants is less than a predetermined amount.

23. The method of claim 1, further comprising assessing the concentration of bacteria in the metalworking fluid prior to introducing the metalworking fluid into the fluid treatment system, wherein the metalworking fluid is inhibited from entering the fluid treatment system if the concentration of bacteria is less than a predetermined amount.

24. The method of claim 1, wherein at least one vortex nozzle unit comprises a vortex nozzle comprising a nozzle body including a passageway therethrough and a plurality of ports that inlet a fluid flow substantially tangential and normal to the passageway; and an end cap attached to the nozzle body.

25. A metalworking fluid system comprising:
a reservoir comprising metalworking fluid, wherein the reservoir is configured to provide metalworking fluid to metalworking machinery, and wherein the metalworking fluid comprises biological contaminants;
a fluid treatment system, the fluid treatment system comprising a first vortex nozzle unit and a second vortex nozzle unit positioned in substantially opposed relation to the first vortex nozzle unit;
a first conduit coupling the reservoir to an inlet of the fluid treatment system; and a second conduit coupling an outlet of the fluid treatment system to the reservoir.

26-33. (canceled)

34. The system of claim 25, further comprising an additive conduit coupled to at least one of the first vortex nozzle unit and the second vortex nozzle unit, wherein the additive conduit is configured to allow addition of an additive to the metalworking fluid as the metalworking fluid passes through the first and/or second vortex nozzle unit.

35. (canceled)

36. The system of claim 25, further comprising a water conduit coupled to first conduit, the third conduit positioned to allow the addition of water to the metalworking fluid prior to the metalworking fluid entering the fluid treatment system.

37. (canceled)
